(19) United States
(12) Patent Application Publication
(10) Pub. No.: US 2026/0233782 A1
(43) Pub. Date: Aug. 13, 2026

(54) SYSTEM WITH INSULATION ELEMENTS

(71) Applicant: SIKA TECHNOLOGY AG, Baar (CH)

(72) Inventors: Roman KRUCKER, Zürich (CH); Henrik LINDGREN, Feluy (BE); Helene LUESCHER, Märstetten (CH); Wayan MUELLER, St. Gallen (CH); Felix WEISS, Wilen / Gottshaus (CH)

(73) Assignee: SIKA TECHNOLOGY AG, Baar (CH)

(21) Appl. No.: 19/472,575

(22) PCT Filed: Apr. 8, 2024
(86) PCT No.: PCT/EP2024/059515

§ 371 Date: Oct. 3, 2025

(30) Foreign Application Priority Data
Apr. 6, 2023 (EP) 23167044.9

(51) Int. Cl. B62D 25/00; B62D 29/00; B65D 71/06

(52) U.S. Cl. CPC B62D 25/00; B62D 29/00; B65D 71/06

(57) ABSTRACT

A system including: a plurality of identical insulation elements for insulating a structural element in a motor vehicle, wherein each insulation element has a carrier and an expandable material which is arranged on the carrier, wherein adjacent insulation elements lie on one another via contact points and are arranged substantially parallel to one another and, as a result, form a stack and define a stack direction; at least one binding element which exerts a force on an uppermost insulation element of the stack in a direction counter to the stack direction, and exerts a force on a lowermost insulation element of the stack in a direction in the stack direction, with the result that the stack is bound together by way of the at least one binding element.

The invention relates to a system comprising insulation elements for sealing off structural elements in a motor vehicle. The invention further relates to a method of mounting such insulating elements on structural elements.

In many cases, components such as, for example, vehicle bodies and/or frames of means of transport and locomotion, especially of water or land vehicles or of aircraft, have structures with cavities in order to enable lightweight constructions. However, these cavities cause a wide variety of problems. Depending on the type of the cavity, the latter has to be sealed in order to prevent the ingress of moisture and soiling, which can lead to corrosion of the components. It is often also desirable to substantially reinforce the cavities and hence the component, but to maintain the low weight. It is often also necessary to stabilize the cavities and hence the components, in order to reduce noise which would otherwise be transmitted along or through the cavity. Many of these cavities have an irregular shape or a narrow extent, which makes it more difficult to seal, reinforce and insulate them properly.

Especially in automotive construction, but also in aircraft construction and boatbuilding, sealing elements (baffles) are therefore used in order to seal and/or acoustically insulate cavities, or reinforcing elements (reinforcers) are used in order to reinforce cavities.

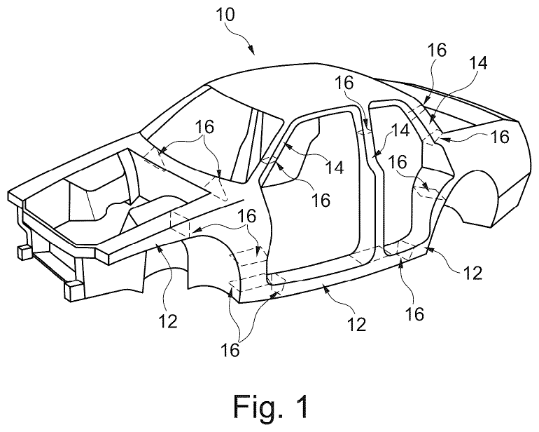

FIG. 1 is a schematic diagram of an automobile body. The vehicle body 10 here has various structures with cavities, for example pillars 14 and beams or crossbeams 12. Such structural elements 12, 14 with cavities are typically sealed or reinforced with insulating elements 16.

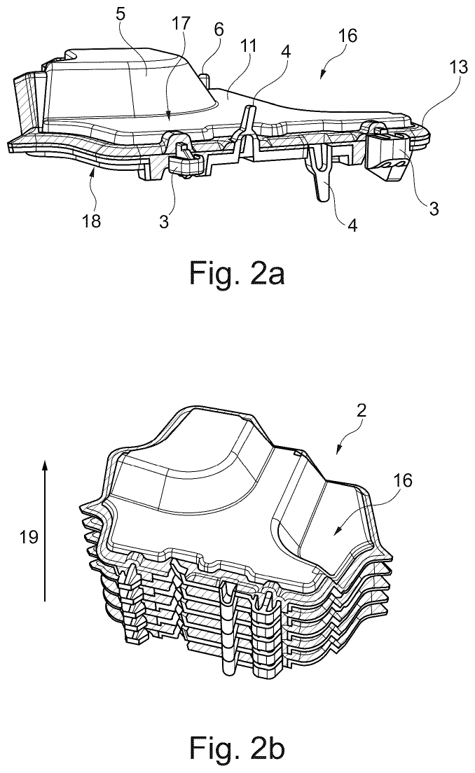

WO2021/069120 already discloses stacking such insulating elements 16. FIGS. 2a and 2b show an example of such a known stackable insulating element 16. This insulating element 16 has a carrier 11 and an expandable material 13 arranged on this carrier 11. In this case, the insulating element 16 is not completely flat, but rather has various elevations and stepped shoulders, in particular a steep step 5.

The insulating element 16 has a top side 17 and a bottom side 18. Moreover, the insulating element 16 in this working example has two fixing elements 3, which are each in the form of a clip, and two spacer elements 4, which are each aligned on different sides. Moreover, the insulating element 16 has a support element 6 which, in this working example, is disposed on the top side 17 of the insulating element 16.

FIG. 2b shows a stack 2 having a plurality of insulating elements 16 according to FIG. 2a. The insulating elements 16 are stacked here one on top of another in a stacking direction 19. The stacked insulating elements 16 are arranged here parallel to one another and each lie one on top of another at the contact sites on their top side and bottom side.

However, it is a disadvantage of these known stackable insulating elements that such stacks are often insufficiently stable in the course of transport or manipulation, and individual insulating elements or several insulating elements together can fall off the stack, especially in the case of insulating elements that have a low degree of nesting because of their shape.

It is therefore an object of the present invention to provide an improved system comprising insulating elements for sealing off structural elements in a motor vehicle that avoids the disadvantages of the prior art. In particular, the system is intended to improve transportability and manipulability of the insulating elements.

This object is firstly achieved by a system comprising: multiple identical insulating elements for sealing off a structural element in a motor vehicle, each insulating element having a carrier and an expandable material disposed on the carrier, wherein adjacent insulating elements lie against one another via contact sites and are arranged essentially parallel to one another and hence form a stack and define a stacking direction; at least one binding element which exerts a force in a direction opposite to the stacking direction on an uppermost insulating element of the stack, and exerts a force in a direction in stacking direction on a lowermost insulating element of the stack, such that the stack is bound together by the at least one binding element.

The system proposed here offers the advantage that the use of an additional binding element crucially improves the stability of the stack. This makes it possible, for example, to more efficiently pack stacks stabilized in this way into a vessel for transport or to unpack them. Furthermore, it is possible in this way to effectively prevent a possible collapse of a stack during transport.

Another advantage can be considered to be that the systems proposed here can be handled as autonomous units and without further aids such as vessels or the like, either in automated systems by robots or in non-automated systems by operators. For example, the bound systems can be stored or transported directly on pallets or molded trays or the like, such that less packaging material is required.

In addition, the use of such binding elements has the advantage that the binding element itself can serve as an information carrier. This can reduce the risk of misidentifications. It is sometimes the case, for example, that similarly shaped insulating elements are mounted at different sites in a vehicle body. In particular, there are also situations where a mirror-image insulating element is used on a left-hand and right-hand side of the vehicle body. In these and similar situations, there is the risk that an incorrect insulating element will be used at a particular site, or that left-hand and right-hand insulating elements will be confused. The additional means of providing information on the binding element can largely prevent such incorrect manipulations.

The claimed system offers a simple solution to a complex problem for which solutions have been sought for some time. The system can support and drive the automated use of stacked insulating elements.

In the context of this invention, the term “insulating element” encompasses elements for closing off and/or sealing off and/or closing and/or reinforcing and/or insulating a structural element. These different characteristics of such an insulating element may occur individually or in combination with one another. In particular, the insulating element can also be used as a baffle [sealing and/or acoustic sealing-off of cavities] or reinforcers [reinforcement of cavities].

In the context of this invention, the terms “top side” and “bottom side” mean in each case the two main surfaces or the two largest lateral faces of the insulating element. Since the insulating elements are designed to close a cross section in a structural element, this means that the top side and the bottom side are each essentially in a plane of a cross section to be sealed off in a state of use. In this respect, the top side and the bottom side may also have a stepped character, meaning that it is unnecessary for the top side and the bottom side to be completely flat.

In the context of this invention, the word “parallel” in relation to the arrangement of insulating elements in a stack of several identical insulating elements means that the same surfaces and/or edges of the identical insulating elements are respectively arranged essentially parallel to one another.

In an illustrative embodiment, the insulating elements each comprise: a carrier; and an expandable material disposed on the carrier; wherein the insulating element has a top side and a bottom side which, in a state of use, are aligned essentially in a plane of a cross section of the structural element that is to be sealed off.

In an illustrative embodiment, several systems comprising bound insulation elements are disposed in a vessel.

In a first development, the several systems each comprise identical insulating elements. In an alternative second development, the several systems each comprise different insulating elements.

In one working example, the vessel takes the form of a box, crate or carton.

In an illustrative embodiment, the insulating element has at least one or at least two or at least three contact sites on each of the top side and the bottom side, where these contact sites are designed such that, when a plurality of identical insulating elements are stacked, respectively adjacent insulating elements lie against one another via these contact sites and are thus arranged parallel to one another.

In an illustrative embodiment, the insulating element has exactly three contact sites on each of the top side and the bottom side, and these contact sites lie against one another when adjacent insulating elements are stacked.

In an alternative development, the insulating element has exactly four or at least four such contact sites on the top side and on the bottom side.

In a further alternative embodiment, the insulating element has exactly five or at least five such contact sites on the top side and on the bottom side.

In an illustrative embodiment, at least one contact site on the top side and a contact site assigned thereto on the bottom side are formed in such a way that adjacent insulating elements are safeguarded against horizontal displacement in the case of stacking in vertical direction.

In an illustrative development, at least one contact site on the top side and a contact site assigned thereto on the bottom side are formed in such a way that, on stacking, there is mechanical locking between the corresponding contact sites.

In an illustrative embodiment, at least one contact site lies in a region of a fixing element. In the context of this invention, a “region of a fixing element” means the fixing element itself, a base of the fixing element, and the expandable material at the base of the fixing element that is required to seal off the opening in the structural element in which the fixing element is inserted.

In an illustrative embodiment, the fixing element is in the form of a clip.

In an alternative embodiment, the fixing element is in the form of a lug, weld lug, bracket, hook, or rivet.

In an illustrative embodiment, the fixing element is formed from plastic, especially polyamide, or from metal.

In an illustrative embodiment, at least one contact site is in the form of a spacer element, where the spacer element serves to support and/or position the insulating element on the structural element in a state of use of the insulating element in the structural element.

In an illustrative development, the spacer element is configured to be stackable per se, where two spacer elements stacked one inside the other have a total height in stacking direction of at most 170% or at most 160% or at most 150% or at most 140% or at most 130% of a height of an individual spacer element.

In an illustrative embodiment, steps of the carrier form an angle to the stacking direction of at least 35° or at least 40° or at least 45° or at least 50° or at least 55°.

The advantage of steps configured in this way is that insulating elements with flatter steps can be stacked more readily than would be the case with steeper steps. In the case of steeper steps, there is the problem in particular that adjacent insulating elements cannot be arranged vertically one above another without a horizontal offset.

In an illustrative embodiment, at least one contact site is in the form of a support element which protrudes from a general surface of the top side or the bottom side of the insulating element in stacking direction.

In an illustrative embodiment, all or individual contact sites are formed by the carrier.

In an alternative embodiment, all or individual contact sites are formed by the expandable material.

In a further embodiment, at least one contact site is formed by the carrier, and at least one contact site is formed by the expandable material.

Since the carrier can generally be produced with smaller tolerances than the expandable material, it may be advantageous for the contact sites to be formed as far as possible by the carrier.

In an illustrative embodiment, the binding element has a modulus of elasticity of at least 0.5, in particular of at least 1 GPa. This means that the binding element is not of highly elastic configuration like rubber, for example, with a modulus of elasticity of 0.01-0.1 GPa.

The modulus of elasticity is also called Young's Modulus or tensile modulus. The modulus of elasticity, in particular the tensile modulus, can be determined according to ASTM Re-003-F with samples of 25×25×9 mm3 or ISO 527-1 or ISO 37 at a temperature of 23° C., a humidity of 50% RH and a speed of 1 mm/min. The modulus of elasticity is a measure of the stiffness of an elastic material. It is used to describe the elastic properties of objects such as tapes as a binding element when they are stretched or compressed. The modulus of elasticity is defined as the “ratio of stress (force per unit of area) along an axis to strain (ratio of deformation over the original length) along that axis”. It can be used to predict the elongation or compression of an object (binding element), provided that the stress is lower than the yield point of the material.

In an illustrative embodiment, the binding element is weldable, in particular weldable to itself. This allows the length of the binding element to be matched individually to the size of the stack. The binding element can be cut to length according to the circumference of the stack. After cutting to length, the binding element can be placed on top of another with an overlap. The overlap is heated, resulting in welding of the overlap. Welding can also be accomplished using an automatic wrapping machine that cuts the binding element to length according to the stack size, overlays the overlap and heats the overlap.

In one working example, the bound stack can be removed from the vessel by the binding element. The binding element here must have low elasticity such that the stack can be removed from the vessel essentially without seesaw movements. The modulus of elasticity of the binding element here may be at least 0.5 GPa or greater.

In an illustrative embodiment, the insulating element has at least one securing element which is formed in such a way that, when the insulating elements are stacked one on top of another, an insulating element is secured by the securing element of an adjacent insulating element against displacement transverse to the stacking direction and/or against rotation of the insulating element about the stacking direction.

In an illustrative embodiment, the securing element is formed in such a way that, when the insulating elements are stacked one on top of another, the securing elements of two adjacent insulating elements overlap in stacking direction.

In an illustrative development, the securing elements overlap in stacking direction by at least 3 mm or by at least 5 mm or by at least 7 mm.

In an illustrative embodiment, the securing element has at least one guide surface which is formed such that, in the case of stacking, the guide surface guides an insulating element to be stacked, with the result that the newly stacked insulating element is arranged on the insulating element substantially congruently in stacking direction.

In an illustrative embodiment, at least one spacer element is configured as a securing element.

In an illustrative development, the spacer element has a substantially Y-shaped configuration. For example, individual surfaces of the legs of the Y-shaped spacer element here may be in the form of a guide surface.

In an alternative development, the spacer element is substantially U-shaped or V-shaped. Again, individual surfaces of the legs of the U-shaped or V-shaped spacer element here may be in the form of a guide surface.

In an illustrative embodiment, at least one step is configured as a securing element.

In an illustrative embodiment, at least one region of a fixing element is configured as a securing element.

In an illustrative development, a base of the fixing element is configured as a securing element. This base may, for example, have a substantially U-shaped form. In turn, in this case individual surfaces of the legs of the U-shaped base of the fixing element may be in the form of guide surfaces.

In an illustrative embodiment, all or individual securing elements are formed by the carrier.

In an alternative embodiment, all or individual securing elements are formed by the expandable material.

In a further embodiment, at least one securing element is formed by the carrier, and at least one securing element is formed by the expandable material.

Since the carrier can generally be produced with smaller tolerances than the expandable material, it may be advantageous for the carrier to form the securing elements as far as possible.

The insulating element has a stack height which corresponds to an additional height in stacking direction of a stack having insulating elements by which the stack grows when a further insulating element is stacked onto the stack.

In an illustrative embodiment, a stack height of the insulating element is at most 80%, preferably at most 70%, preferably at most 60%, preferably at most 50%, preferably at most 40%, preferably at most 30%, of a total height of an individual insulating element in stacking direction.

This has the advantage that it allows the insulating elements to be arranged in a stack in a more space-saving manner. A greater degree of vertical nesting of adjacent insulating elements in a stack additionally improves the stability of the overall stack.

In the case of stacked insulating elements, in an illustrative embodiment, each additional insulating element increases the height of the stack by at most 20 mm, especially preferably by at most 18 mm, especially preferably by at most 16 mm, especially preferably by at most 14 mm, especially preferably by at most 12 mm, especially preferably by at most 10 mm.

The close stacking of insulating elements has the advantage that this allows the insulating elements to be packed and transported more efficiently.

In an illustrative embodiment, a stack comprises at least ten or at least fifteen or at least twenty or at least twenty-five or at least thirty stacked insulating elements.

In a further illustrative embodiment, a stack comprises at most 150 or at most 120 or at most 100 or at most 80 or at most 60 stacked insulating elements.

In an illustrative embodiment, the binding element abuts the lowermost and/or the uppermost insulating element over an area of an outwardly oriented surface of the stack which is aligned essentially orthogonally to the stacking direction.

This has the advantage that the binding element can thus be arranged repeatably at a predefined site and in any system, and that sliding or slipping of the binding element on inclined surfaces can be avoided.

In an illustrative embodiment, the binding element abuts an outwardly oriented surface of the stack at a site that forms a depression relative to adjacent sites on this surface. This has the advantage that the binding element can thus be secured against sliding or slipping. In an illustrative embodiment, the binding element defines a plane of intersection through the stack which runs through abutment sites of the binding element and which additionally runs in such a way that the stacking direction extends in this plane of intersection, wherein contact sites between adjacent insulating elements are distributed in such a way that such contact sites exist on both sides of this plane of intersection.

This has the advantage that this can further improve stability of the system. The provision of contact sites on both sides of the plane of intersection effectively prevents the binding force of the binding element from putting the stack of insulating elements in an oblique position.

In an illustrative embodiment, the binding element applies force to each of the uppermost and the lowermost insulating elements of the stack only at one point and/or along one line.

In an alternative embodiment, the system comprises at least two binding elements, wherein force is applied to each of the uppermost and/or the lowermost insulating elements of the stack at at least two separate sites.

Depending on the shape of the insulating element, and depending on the stack height of the stack or the number of insulating elements in a stack, it is possible to choose a suitable variant with regard to the number and supporting of the binding elements.

In an illustrative embodiment, the at least one binding element is designed as a strip.

This has the advantage that such strips are inexpensive, that little waste is generated thereby, that such strips can be used universally and for various forms of insulating elements, and that information about the product and/or its use can be simply printed or glued onto such strips.

In an alternative embodiment, the at least one binding element is designed as a bracket. This has the advantage that such brackets can be formed as reusable elements that are not destroyed when removed from the stack. This means that an environmentally friendly and resource-conserving variant can be provided.

In a further alternative embodiment, the at least one binding element is designed as a box. In an illustrative development, surfaces on inner walls or on the inside of the lid and/or additional force-applying elements such as springs and/or projections serve as force-transmitting elements on the lowermost or uppermost insulating element of a stack.

This has the advantage that this allows use of a vessel as binding element, such that there is no need to use an additional vessel, for example for transport of the stacked insulating elements.

In an illustrative embodiment, at least one piece of information relating to the bound insulating elements is mounted on the binding element.

This has the advantage that this can ensure correct logistics in a process of use of the insulating elements. Since the insulating elements cannot be removed individually owing to the binding element, it is thus possible to avoid unintentional misidentifications that can arise through removal of individual insulating elements.

For example, a barcode may be printed on the binding element, such that a robot and/or an operator is able to correctly identify and continue to use the insulating elements of a system.

The expandable material used may in principle be various materials that can be made to foam. This material may or may not have reinforcing properties. Typically, the expandable material is made to expand thermally, by moisture or by electromagnetic radiation.

Such an expandable material typically has a chemical or a physical blowing agent. Chemical blowing agents are organic or inorganic compounds which decompose under the influence of temperature, moisture or electromagnetic radiation, where at least one of the decomposition products is a gas. Physical blowing agents used may, for example, be compounds that are converted to the gaseous state of matter with increasing temperature. As a result, both chemical and physical blowing agents are capable of creating foam structures in polymers.

The expandable material is preferably foamed thermally, using chemical blowing agents. Examples of suitable chemical blowing agents are azodicarbonamides, sulfohydrazides, hydrogencarbonates or carbonates.

Suitable blowing agents are also commercially available, for example, under the Expancel® trade name from Akzo Nobel, the Netherlands, or under the Celogen® trade name from Chemtura Corp., USA.

The heat required for the foaming can be introduced by external or by internal heat sources, such as an exothermic chemical reaction. The foamable material is preferably foamable at a temperature of ≤250° C., especially of 100° C. to 250° C., preferably of 120° C. to 240° C., preferably of 130° C. to 230° C.

Suitable expandable materials are, for example, one-component epoxy resin systems which do not flow at room temperature and in particular have elevated impact resistance and contain thixotropic agents such as aerosils or nanoclays. For example, epoxy resin systems of this type include 20% to 50% by weight of a liquid epoxy resin, 0% to 30% by weight of a solid epoxy resin, 5% to 30% by weight of impact modifiers, 1% to 5% by weight of physical or chemical blowing agents, 10% to 40% by weight of fillers, 1% to 10% by weight of thixotropic agents and 2% to 10% by weight of heat-activatable curing agents. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing blowing agents and based on crystalline polyesters which have OH groups and have been mixed with further polyols, preferably polyether polyols, and polyisocyanates with blocked isocyanate groups. The melting point of the crystalline polyester should be ≥50° C. The isocyanate groups of the polyisocyanate may be blocked, for example, by nucleophiles such as caprolactam, phenols or benzoxalones. Also suitable are blocked polyisocyanates as used, for example, in powder-coating technology, and commercially available, for example, under the Vestagon® BF 1350 and Vestagon® BF 1540 trade names from Degussa GmbH, Germany. Suitable isocyanates are also what are called encapsulated or surface-deactivated polyisocyanates, which are known to the person skilled in the art and are described, for example, in EP 0 204 970.

Also suitable as expandable materials are two-component epoxy/polyurethane compositions which contain blowing agents, as described, for example, in WO 2005/080524A1 .

Also suitable as expandable materials are ethylene-vinyl acetate compositions containing blowing agents.

Expandable materials that are likewise suitable are sold by Sika Corp., USA, for example under the SikaBaffle® 240, SikaBaffle® 250 or SikaBaffle® 255 trade name, and are described in patents U.S. Pat. No. 5,266,133 and U.S. Pat. No. 5,373,027. Such expandable materials are particularly preferred for the present invention.

Preferred expandable materials having reinforcing properties are, for example, those which are sold under the SikaReinforcer® 941 trade name by Sika Corp., USA. These are described in U.S. Pat. No. 6,387,470.

In an illustrative embodiment, the expandable material has an expansion rate of 800% to 5000%, preferably of 1000% to 4000%, more preferably of 1500% to 3000%. Expandable materials having such expansion rates offer the advantage that, as a result, reliable sealing or sealing-off of the structural element with respect to liquids and sound can be achieved. In an illustrative embodiment, the expandable material is in the form of a temperature-induced material.

This has the advantage that, as a result, the furnace for baking the dipcoating liquid can be used to expand the expandable material and hence to seal off the cavity. Consequently, no additional working step is required.

The carrier may consist of any desired materials. Preferred materials are plastics, especially polyurethanes, polyamides, polyesters and polyolefins, preferably polymers which can withstand high temperatures such as poly(phenylene ethers), polysulfones or polyether sulfones, which in particular are also foamed; metals, especially aluminum and steel; or grown organic materials, especially wood materials or other (densified) fibrous materials, or vitreous or ceramic materials; especially also foamed materials of this type; or any desired combinations of these materials. Particular preference is given to using polyamide, especially nylon-6, nylon-6,6, nylon-11, nylon-12 or a mixture thereof.

Furthermore, the carrier may be solid, hollow and/or foamed and/or have a meshlike structure, for example. Typically, the surface of the carrier may be smooth, rough or structured.

In the case of insulating elements in which the expandable material is on a carrier, the production process differs according to whether or not the carrier consists of a material that can be processed by injection molding. If this is the case, a two-component injection molding process is typically used. This involves first injecting a first component, in this case the carrier. After said first component has solidified, the cavity in the mold is enlarged, or adapted, or the molding produced is placed into a new mold, and a second component, in this case the expandable material, is overmolded onto the first component by a second injection apparatus.

If the carrier consists of a material that cannot be produced by the injection molding process, i.e., for example, consists of a metal, the carrier is placed into a corresponding mold and the expandable material is overmolded onto the carrier. Of course, it is also possible to fasten the expandable material to the carrier by specific fastening means or processes.

Furthermore, carriers can also be produced by other processes, for example by extrusion. The object stated at the outset is additionally achieved by a method ff mounting insulating elements on structural elements of motor vehicles, said method comprising the steps of: providing a system having stacked and mutually bound insulating elements; transferring the system to a picking site; removing the binding element or the binding elements; picking a single insulating element from the stack; and mounting the insulating element on the structural element of the motor vehicle.

In an illustrative embodiment, the method is conducted with an above-described system. The removing of the binding element or the binding elements may precede or follow the transferring or the picking.

In an illustrative embodiment, the provision and/or the transfer and/or the removal and/or the picking and/or the mounting is performed by an application robot.

This has the advantage that it is possible thereby to automate individual steps of this method, or the entire method, making the overall method more efficient in terms of time and costs.

In an illustrative embodiment, the application robot manipulates several systems with different insulating elements.

In an illustrative embodiment, the insulating elements, in the transfer operation, are arranged in at least one rack which can accommodate several insulating elements and which can hold the insulating elements ready in a predefined picking position.

In an illustrative development, the rack has at least one guide element that at least partly follows an outline of an insulating element.

In an illustrative development, the at least one guide element or the plurality of guide elements are designed such that the insulating elements are accommodatable in only one spatial position therein.

In an illustrative embodiment, a respectively dedicated rack is provided for each different type of insulating elements envisaged for the method. In particular, each rack has guide elements configured such that only the intended type of insulating element can be disposed therein.

The providing of separate and type-specific racks has the advantage that this can avoid incorrect manipulations. In addition, this can save space, since such racks take up less space than open vessels, for example.

In an illustrative embodiment, the robot comprises a multiarticulated robot arm and a gripper disposed thereon.

In an illustrative embodiment, the structural element takes the form of a single metal sheet, or of a plurality of metal sheets bonded to one another, especially columns or beams or crossbeams, or of a constituent of a vehicle body, or of a vehicle body.

In an illustrative embodiment, the structural element has at least one opening, and the insulating element has at least one fixing element, where these two elements are designed such that the fixing element can be locked into the opening.

In an illustrative embodiment, in the mounting operation, a fixing element of the insulating element is locked into an opening of the structural element.

In an illustrative embodiment, an above-described system is designed such that an above-described method can be executed therewith.

Details and advantages of the invention will be described hereinafter using working examples and with reference to schematic drawings. The figures show:

FIG. 1 an illustrative diagram of a vehicle body;

FIGS. 2a and 2b a schematic diagram of an illustrative insulating element or of a stack with a plurality of such insulating elements;

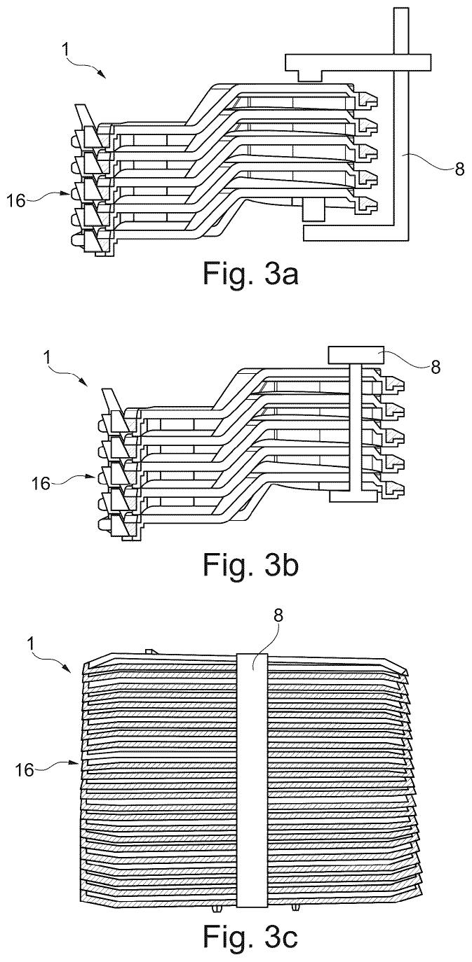

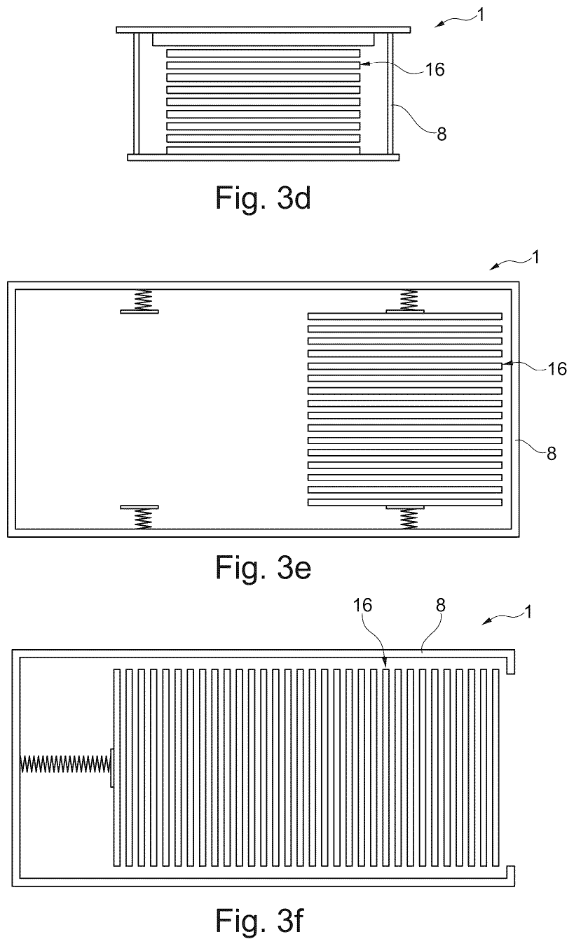

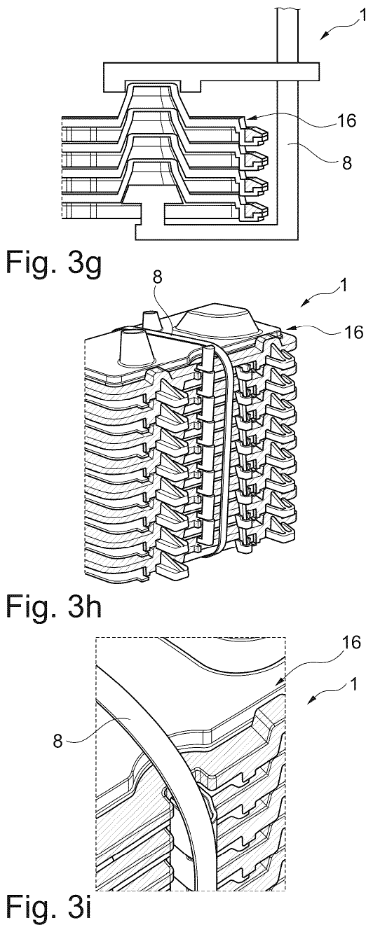

FIGS. 3a to 3i a schematic diagram of an illustrative system of bound insulating elements;

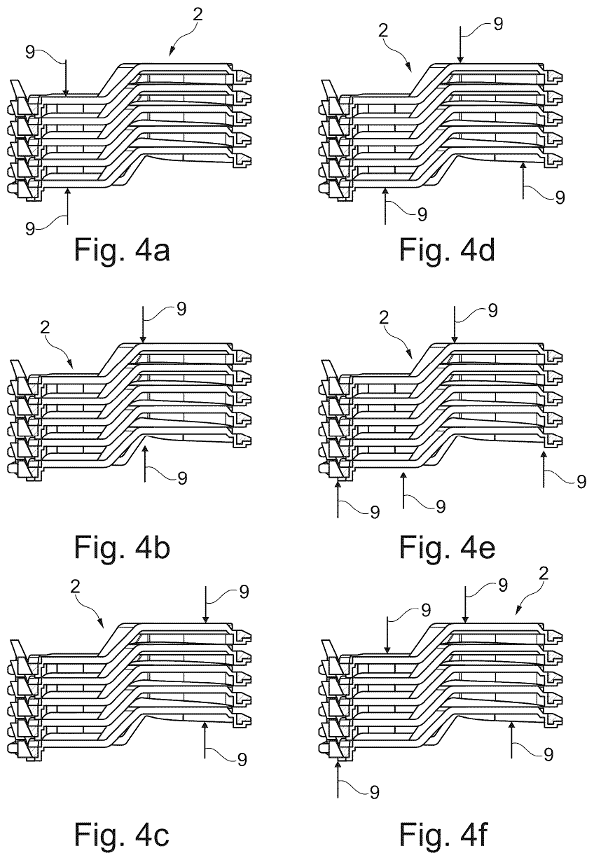

FIGS. 4a to 4f a schematic diagram of an illustrative stack of insulating elements with illustrative contact sites of forces from a binding element;

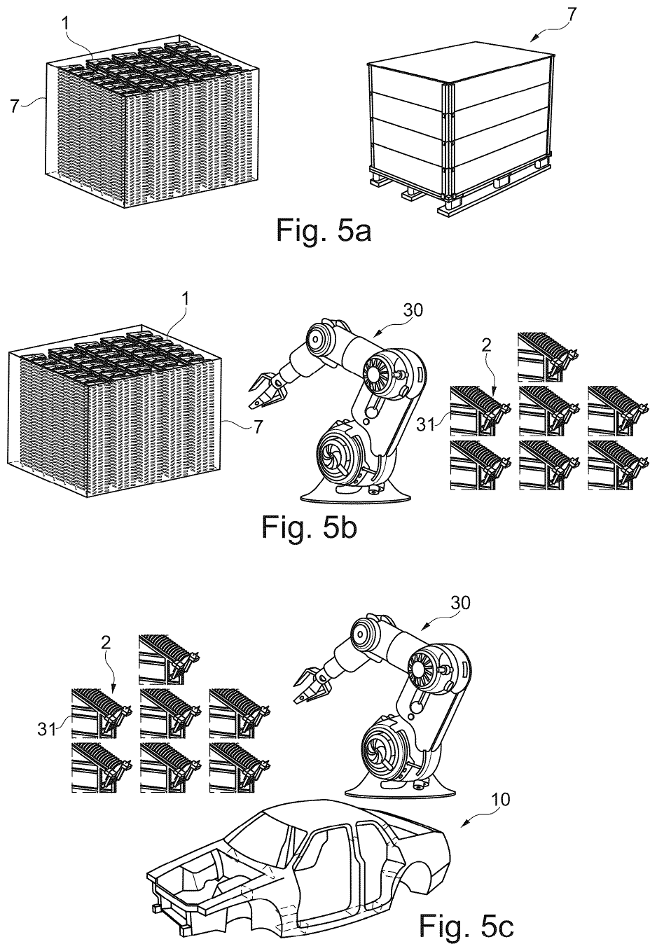

FIGS. 5a to 5c a schematic diagram of an illustrative method of mounting insulating elements on structural elements in motor vehicles; and

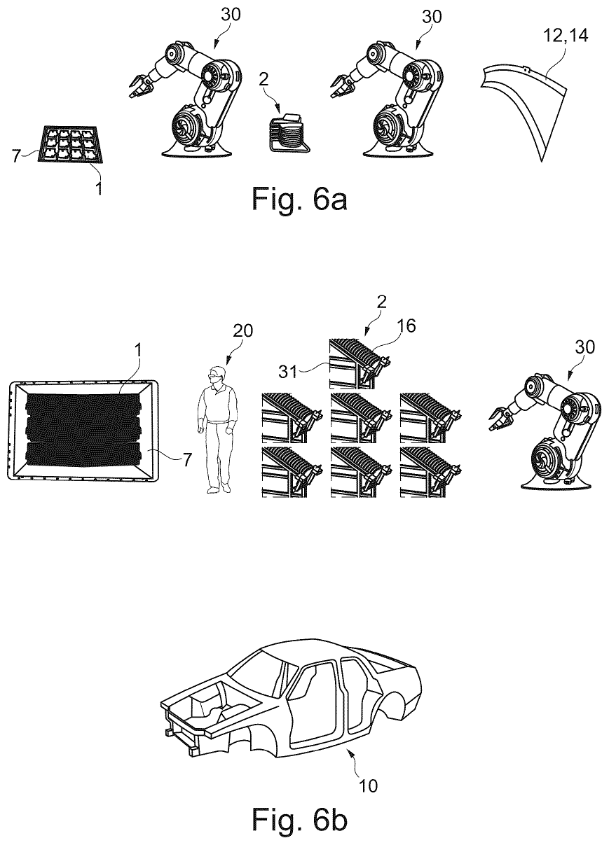

FIGS. 6a and 6b a schematic diagram of an illustrative method of mounting insulating elements on structural elements in motor vehicles.

FIGS. 3a to 3i show various illustrative systems 1 of bound insulating elements 16.

FIG. 3a shows a first illustrative embodiment of a binding element 8. The binding element 8 here is designed as a bracket which clamps the stack of the insulating elements 16 by exerting a force on the uppermost and the lowermost insulating element 16 of the stack.

FIG. 3b shows a second illustrative embodiment of a binding element 8. The binding element 8 here is designed as a threaded bar with nuts which clamps the stack of the insulating elements 16 by exerting a force on the uppermost and the lowermost insulating element 16 of the stack via the nuts that are screwed on.

FIG. 3c shows a third illustrative embodiment of a binding element 8. The binding element 8 here is designed as a strip which clamps the stack of the insulating elements 16 by exerting a force on the uppermost and the lowermost insulating element 16 of the stack.

In this execution variant, the insulating elements 16 are additionally safeguarded against lateral slippage by the strip.

FIG. 3d to 3f show various variants of a fourth illustrative embodiment of a binding element 8. The binding element 8 here is designed as a box which clamps the stack of the insulating elements 16 by exerting a force on the uppermost and the lowermost insulating element 16 of the stack. In this case, inner faces of the box can exert a force directly on the insulating elements, or else additional elements such as springs or projections may be provided, which exert a force in a controlled manner on the uppermost and the lowermost insulating element 16 of the stack.

FIG. 3g shows a further illustrative embodiment of a binding element 8. The binding element 8 here is designed as a bracket which clamps the stack of the insulating elements 16 by exerting a force on the uppermost and the lowermost insulating element 16 of the stack. In this execution variant, the bracket has specifically shaped contact sites which each engage into complementarily shaped sites in the lowermost or the uppermost insulating element 16. This can prevent unwanted sliding or slipping of the bracket.

FIG. 3h shows a further illustrative embodiment of a binding element 8. The binding element 8 here is designed as a strip which clamps the stack of the insulating elements 16 by exerting a force on the uppermost and the lowermost insulating element 16 of the stack. In this execution variant, the strip lies on the uppermost insulating element 16 in a depression relative to adjacent areas of the surface. This prevents unwanted sliding or slipping of the strip.

FIG. 3i shows a further illustrative embodiment of a binding element 8. The binding element 8 here is again designed as a strip. In this execution variant, the belt lies in a depression of the lateral regions of the insulating elements 16. As a result, the belt is guided in a lateral region of the stack and safeguarded against unwanted sliding or slipping.

FIGS. 4a to 4f schematically and illustratively show stacks 2 of insulating elements 16 with illustrative contact sites of forces 9 from a binding element.

In FIGS. 4a to 4c, a force 9 from the binding element (not shown in these figures) acts only at one site on the lowermost or the uppermost insulating element 16.

In FIGS. 4d to 4f, at least on one of the insulating elements 16, more than one force 9 acts on more than one site on the insulating element 16. This can be executed, for example, by means of multiple binding elements, or by means of one binding element with multiple contact sites.

In all the exemplary embodiments according to FIGS. 4a to 4f, the binding element (not shown) defines a plane of intersection through the stack 2 which runs through abutment sites of the binding element and which additionally runs in such a way that the stacking direction extends in this plane of intersection, wherein contact sites between adjacent insulating elements 16 are distributed in such a way that such contact sites exist on both sides of this plane of intersection.

FIGS. 5a to 5c schematically and illustratively show a first method of mounting insulating elements 16 on structural elements 12, 14 in motor vehicles.

FIG. 5a shows the provision of systems 1 with stacked and bound insulating elements 16. In this example, the systems 1 are disposed in a vessel 7.

FIG. 5b shows the transferring of the systems 1 to a picking site, and the removing of the binding elements. In this example, the systems 1 are transferred by an application robot 30, and the same application robot 30 also removes the binding elements. At the picking site, it has several racks 31 that accommodate the stacks 2 of the insulating elements 16. In FIG. 5c is finally the picking of individual insulating elements 16 from the stack 2 and the mounting of the insulating elements 16 on the structural element 12, 14 or the body 10 of the motor vehicle. Again, both the picking and the mounting are implemented by an application robot 30.

FIG. 6a schematically and illustratively shows a second method of mounting insulating elements 16 on structural elements 12, 14 in motor vehicles. Again, the systems 1 are provided in a vessel 7, and transferred by an application robot 30. At the picking site, individual insulating elements 16 are picked from the stack 2 by a second application robot 30 and mounted on a structural element 12, 14. In contrast, for example, in FIGS. 5a to 5c, no racks are used in this example.

FIG. 6b schematically and illustratively shows a third method of mounting insulating elements 16 on structural elements 12, 14 in motor vehicles. Frames 31 are again used here at the picking site, and, by contrast with the previous examples, the systems 1 here are transferred by an operator 20 to the picking site, and the removing of the binding elements is also implemented by the operator 20.

### LIST OF REFERENCE NUMERALS

1 system
2 stack
3 fixing element
4 spacer element
5 step
6 support element
7 vessel
8 binding element
9 force
10 vehicle body
11 carrier
12 structural element
13 expandable material
14 structural element
15 stack height of an insulating element
16 insulating element
17 top side
18 bottom side
19 stacking direction
20 operator
30 application robot
31 rack

1. A system comprising:
multiple identical insulating elements for sealing off a structural element in a motor vehicle,
each insulating element having a carrier and an expandable material disposed on the carrier, wherein adjacent insulating elements lie against one another via contact sites and are arranged essentially parallel to one another and hence form a stack and define a stacking direction;
at least one binding element which exerts a force in a direction opposite to the stacking direction on an uppermost insulating element of the stack, and exerts a force in a direction in stacking direction on a lowermost insulating element of the stack, such that the stack is bound together by the at least one binding element.

2. The system as claimed in claim 1, wherein the binding element has a modulus of elasticity of at least 0.5 GPa.

3. The system as claimed in claim 1, wherein each insulating element has at least one securing element designed in such a way that, in the case of insulating elements stacked one on top of another, one insulating element is secured by the securing element of an adjacent insulating element against displacement transverse to the stacking direction and/or against rotation of the insulating element about the stacking direction.

4. The system as claimed in claim 1, wherein at least one contact site lies in a region of a fixing element, and/or wherein the region of the fixing element is in the form of a securing element.

5. The system as claimed in claim 1, wherein the binding element abuts the lowermost and/or the uppermost insulating element over an area of an outwardly oriented surface of the stack which is aligned essentially orthogonally to the stacking direction.

6. The system as claimed in clam 1, wherein the binding element abuts an outwardly oriented surface of the stack at a site that forms a depression relative to adjacent sites on this surface.

7. The system as claimed in claim 1, wherein the binding element defines a plane of intersection through the stack which runs through abutment sites of the binding element and which additionally runs in such a way that the stacking direction extends in this plane of intersection, wherein contact sites between adjacent insulating elements are distributed in such a way that such contact sites exist on both sides of this plane of intersection.

8. The system as claimed in claim 1, wherein the binding element applies force to each of the uppermost and the lowermost insulating elements of the stack only at one point and/or along one line.

9. The system as claimed in claim 1, wherein the system comprises at least two binding elements, wherein force is applied to each of the uppermost and/or the lowermost insulating elements of the stack at at least two separate sites.

10. The system as claimed in claim 1, wherein the at least one binding element takes the form of a band or a bracket or a box.

11. The system as claimed in claim 1, wherein at least one piece of information with respect to the bonded insulating elements is mounted on the binding element.

12. The system as claimed in claim 1, wherein each additional insulating element elevates the stack by not more than 20 mm in stacking direction, and/or wherein a stack height of a single insulating element is not more than 50% of a total height of a single insulating element in stacking direction.

13. A method for mounting insulating elements on structural elements in motor vehicles, the method comprising the steps of:
providing a system having stacked and mutually bound insulating elements as claimed claim 1;
transferring the system to a picking site;
removing the binding element or the binding elements;
picking a single insulating element from the stack; and
mounting the insulating element on the structural element of the motor vehicle.

14. The method as claimed in claim 13, wherein the provision and/or the transfer and/or the removal and/or the picking and/or the mounting is performed by an application robot.

15. The method as claimed in claim 14, wherein the application robot manipulates several systems having different insulating elements.
